(19) United States
(12) Patent Application Publication
(10) Pub. No.: US 2015/0172882 A1
(43) Pub. Date: Jun. 18, 2015

(54) Method For Correlation Of Requesting Information From A Remote Device

(71) Applicant: Alcatel-Lucent USA Inc., Murray Hill, NJ (US)

(72) Inventors: Suzann Hua, Lisle, IL (US); Yigang Cai, Naperville, IL (US)

(73) Assignee: Alcatel-Lucent USA Inc., Murray Hill, NJ (US)

(21) Appl. No.: 14/132,748

(22) Filed: Dec. 18, 2013

(51) Int. Cl. H04W 4/14; H04W 4/00

(52) U.S. Cl. CPC H04W 4/14; H04W 4/005; H04W 4/24

(57) ABSTRACT

A method for requesting information from a remote device includes sending a request to a remote device from a network element. The request includes a data request and an event request ID. The remote device receives the request and sends a response to the network element. The response includes the information requested and the event request ID. The network element receives the response from the remote device.

### FIELD OF THE INVENTION

The present invention relates generally to communication systems.

### BACKGROUND OF THE INVENTION

Due to the nature of small data communication for MTC (Machine Type Communication), SMS (Short Message Service) is a very important underlying communication mechanism for MTC. Today most SMS protocols are single message oriented, which are not designed to handle a thread of messages.

This can be limiting when trying to utilize SMS to receive multiple pieces of data in separate SMS messages, since there is currently no method for correlating disparate SMS messages.

Therefore, a need exists for a way of correlating a thread of SMS messages.

### BRIEF SUMMARY OF THE INVENTION

An exemplary embodiment proposes a new event request ID which uniquely identifies an event request from an MTC server in SMS protocols to support MTC event correlation. With this new, preferably mandatory, event request ID, whenever an MTC service provider triggers an MTC request, an event request ID is created. Such an event request ID is inserted into an event trigger request MT (Mobile Terminated) SMS message sent to the device. After a device receives an event trigger request MT SMS, performs at least one action requested, and sends subsequent MO (Mobile Originated) SMS messages back to the requester, the device includes the original event request ID in the MO SMS messages. The inclusion of the event request ID allows the requester to correlate the MO SMS message with previous MT SMS messages in order to perform necessary functions and actions.

The event request ID proposed is also useful for charging when an MTC service provider would like to charge per event request. Namely, service providers would not charge per message transaction, but per event in which there could be multiple MO and MT SMS transactions in each charged event.

Further, the event request ID proposed can be applicable to both single machine device communication and grouped machine devices communication.

### BRIEF DESCRIPTION OF THE SEVERAL VIEWS OF THE DRAWINGS

FIG. 1 depicts the functional architectural of a communication network in accordance with an exemplary embodiment of the present invention.

FIG. 2 depicts a call flow diagram in accordance with an exemplary embodiment of the present invention.

FIG. 3 depicts a call flow diagram in accordance with an exemplary embodiment of the present invention.

### DETAILED DESCRIPTION OF THE INVENTION

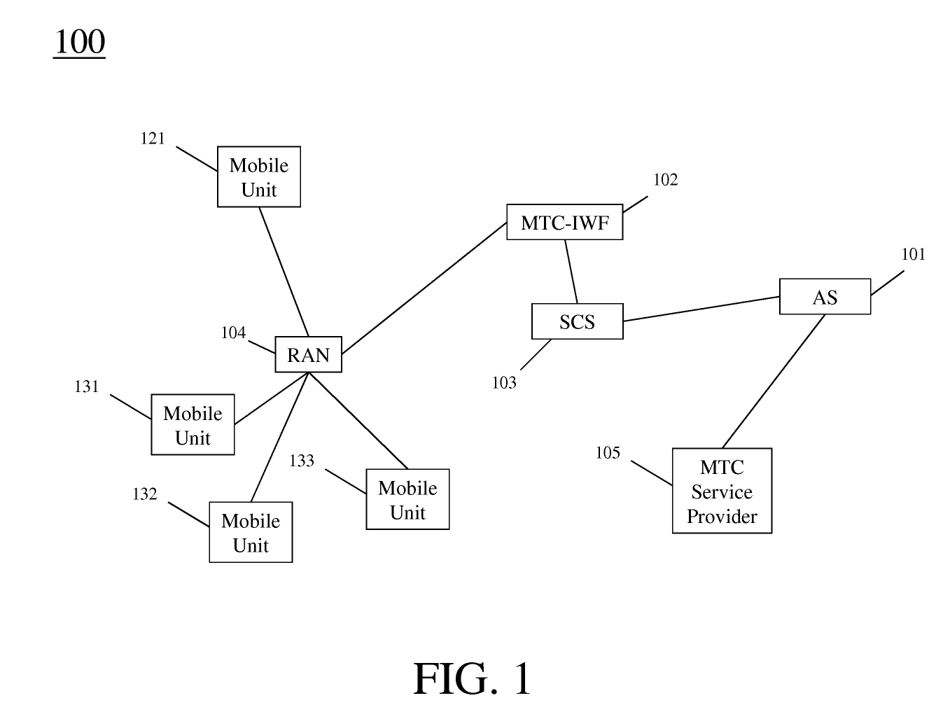

FIG. 1 depicts the functional architectural of communication network 100 in accordance with an exemplary embodiment of the present invention. Network 100 preferably comprises Application Server (AS) 101, MTC-IWF (Machine Type Communication-InterWorking Function) 102, Service Capability Server (SCS) 103, RAN 104, and MTC Service Provider 105. Mobile Units (MU) 121, 131, 132, and 133 communicate with network 100, preferably via RAN 104. Network 100 is preferably a 3GPP Architecture Reference Model for Machine-Type Communication. In accordance with an exemplary embodiment, MTC-IWF 102 and SCS 103 check to determine if the parameter Event Request ID is present in any SMS MO or MT request. If not, they reject the message request.

Application Server (AS) 101 preferably hosts and executes services, such as IMS specific services. AS 101 interfaces with SCS 103, preferably using SIP. AS 101 can operate in SIP proxy mode, SIP UA (user agent) mode or SIP B2BUA mode.

MTC-IWF 102 is operably coupled to SCS 103 and RAN 104. MTC-IWF 102 provides data rate adaption and protocol conversion. MTC-IWF 102 can also be integrated in SMS-SC, SMS-GMSC, or SMS-IWMSC or other appropriate application servers. In accordance with an exemplary embodiment, whenever MTC-IWF 102 receives an event trigger request from SCS 103, MTC-IWF 102 checks if there is an Event Request ID present. If not, MTC-IWF 102 returns an error message and rejects the request.

In accordance with an exemplary embodiment, whenever MTC-IWF 102 sends an SMS request to the MSC/MME/SGSN/SMS-SC/GMSC/IWMSC, MTC-IWF 102 includes a TLV parameter Event Request ID in the PDU body. Whenever MTC-IWF 102 receives an SMS request from the MSC/MME/SGSN/SMS-SC/GMSC/IWMSC, MTC-IWF 102 checks if the TLV parameter Event Request ID is present in the PDU body. If not, the MTC-IWF returns an error message and rejects the request.

When MTC-IWF 102 receives a charging request from the CDF/CGF, MTC-IWF 102 preferably includes the Event Request ID information. Whenever MTC-IWF 102 sends a charging request to the CDF/CGF, MTC-IWF 102 preferably includes the Event Request ID information. This facilitates event based charging.

SCS 103 is a routing gateway for MTC SMS. SCS 103 can be integrated in an SMS-SC, SMS-GMSC, or SMS-IWMSC or other appropriate application servers. In accordance with an exemplary embodiment, SCS 103 creates an Event Request ID prior to delivering a trigger request. In this exemplary embodiment, SCS 103 acknowledges MTC Service Provider 105 with an Event Request ID in a response message to the trigger request from MTC Service Provider 105. MTC Service Provider 105 preferably correlates the response message with the Event Request ID, preferably using the existing message ID in this particular transaction. MTC Service Provider 105 preferably saves the Event Request ID in a local data base for subsequent correlation purposes.

Whenever SCS 103 receives an event trigger request, SCS 103 preferably checks to determine if the request comes with an Event Request ID. If the Event Request ID is missing, SCS 103 preferably returns an error message to reject the request. Optionally, SCS 103 can create an Event Request ID for MTC AS 101 and report the created Event Request ID to MTC AS 101 in the acknowledgement message so MTC AS 101 can correlate subsequent reporting messages from MUs.

When SCS 103 sends an event trigger request to MTC-IWF 102, SCS 103 preferably passes the Event Request ID within the request to MTC-IWF 102.

When SCS 103 sends an SMS request utilizing the SMPP protocol to a GGSN/P-GW, SCS 103 preferably adds a TLV parameter Event Request ID to the PDU body.

When SCS 103 receives an SMS request utilizing the SMPP protocol from a GGSN/P-WG, SCS 103 preferably checks if the TLV parameter Event Request ID is present in the PDU body. If not, SCS 103 preferably returns an error message and rejects the request.

RAN 104 implements a radio access technology and provides communication between MTC-IWF 102 and mobile units 121, 131, 132, and 133. RAN 104.

MTC Service Provider 105 preferably hosts an MTC application server and includes a unique Event Request ID whenever it sends an MTC event trigger request to SCS 103 for machine type devices. The Event Request ID is preferably a character string and includes event information, such as an event name and a timestamp of when the request is made.

MTC Service Provider 105 preferably establishes an associated expiration timer for the Event Request ID. The expiration timer instructs the devices to report event execution per the request and include the Event-Request ID in the report SMS. The expiration timer also provides a window for network elements to cache the Event Request ID in a local database. In an exemplary embodiment, the timer expires with or without a pre-configured extension, and the network elements can clear the Event-Request ID appropriately.

Mobile Units (MU) 121, 131, 132, and 133 are a wireless communication device that can communicate with communication network 100. MUs 121, 131, 132, and 133 are remote units that can communicate with network 100.

MUs 121, 131, 132, and 133 can be mobile devices, such as a cell phone or smart phone, but may alternately be a device or sensor in a Machine-to-Machine (M2M) communication, or the device or sensor of the Internet of Things (IoT).

MUs 121, 131, 132, and 133 are capable of sending and receiving SMS messages. In accordance with an exemplary embodiment, when a machine device, such as MU 121, 131, 132, or 133, receives an SMS request, the machine device checks if the SMS request includes an Event Request ID. The machine device stores the received Event Request ID, preferably as read only data. Once the machine device completes the requested event action, the machine device preferably sends subsequent MO SMS requests back to the requester to report the requested action. The machine device preferably includes the received Event Request ID as a mandatory parameter in the SMS message.

The mobile units also support the storage of the pre-configured read only Event Request IDs that can be used to report periodically pre-scheduled event actions. When a mobile unit sends an SMS report for the completion of such pre-scheduled event action, the machine device also includes an applicable pre-configured Event Request ID in the SMS. The mobile units may follow the expiration timer of the Event Request ID when executing the request and reporting the events.

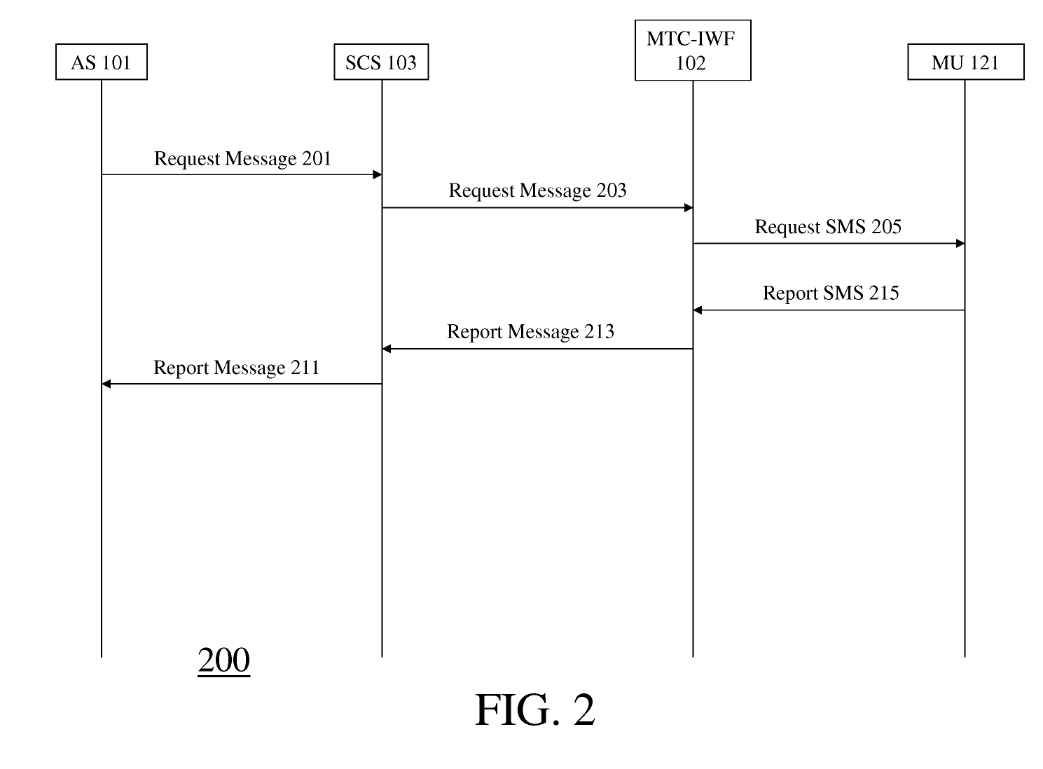

FIG. 2 depicts a call flow diagram 200 in accordance with an exemplary embodiment of the present invention. In this exemplary embodiment, an MTC service provider utilizes an application server to request information from a remote device. For example, the MTC service provider may request temperature information from a patient having a remote thermometer device.

The MTC service provider provides a request to AS 101. The request includes a destination address of a remote machine device and an event request ID. In this exemplary embodiment, the remote machine device is mobile unit 121.

AS 101 sends request message 201 to SCS 103. Request message 201 includes the destination address of MU 121 and the event request ID.

SCS 103 sends request message 203 to MTC-IWF 102. Request message 201 includes the destination address of MU 121 and the event request ID.

MTC-IWF 102 sends request SMS 205 to MU 121. Request SMS 205 includes the event request ID, preferably in the PDU (Protocol Data Unit) body.

MU 121 receives request SMS 205 and saves the event request ID. In an exemplary embodiment, MU 121 saves the event request ID in read-only memory (ROM).

After obtaining the information requested, such as temperature, MU 121 sends report SMS 215 to MTC-IWF 102. Report SMS 215 is an MO SMS. Report SMS 215 includes the information requested, such as temperature, and the event request ID received in request SMS 205. In an exemplary embodiment, the event request ID is included in the PDU body.

MTC-IWF 102 sends report message 213 to SCS 103. Report message 213 includes the information requested and the event request ID.

SCS 103 sends report message 211 to AS 101. Report message 211 includes the information requested and the event request ID.

In accordance with an exemplary embodiment, upon receiving the report message from MU 121, the MTC service provider marks the completion of the event request for the event request ID for MU 121.

In an alternate exemplary embodiment, the MTC service provider may request multiple reports with the same event request ID from MU 121. In this exemplary embodiment, the number of reports and the time interval for sending the reports is included in request message 201. In this exemplary embodiment, MU 121 collects the requested data, such as temperature or other measurements, per interval and reports the collected data in subsequent mobile originated (MO) SMS messages. These MO SMS messages preferably include the event request ID.

The MTC service provider can then correlate the data received in the MO SMS messages by utilizing the event request ID.

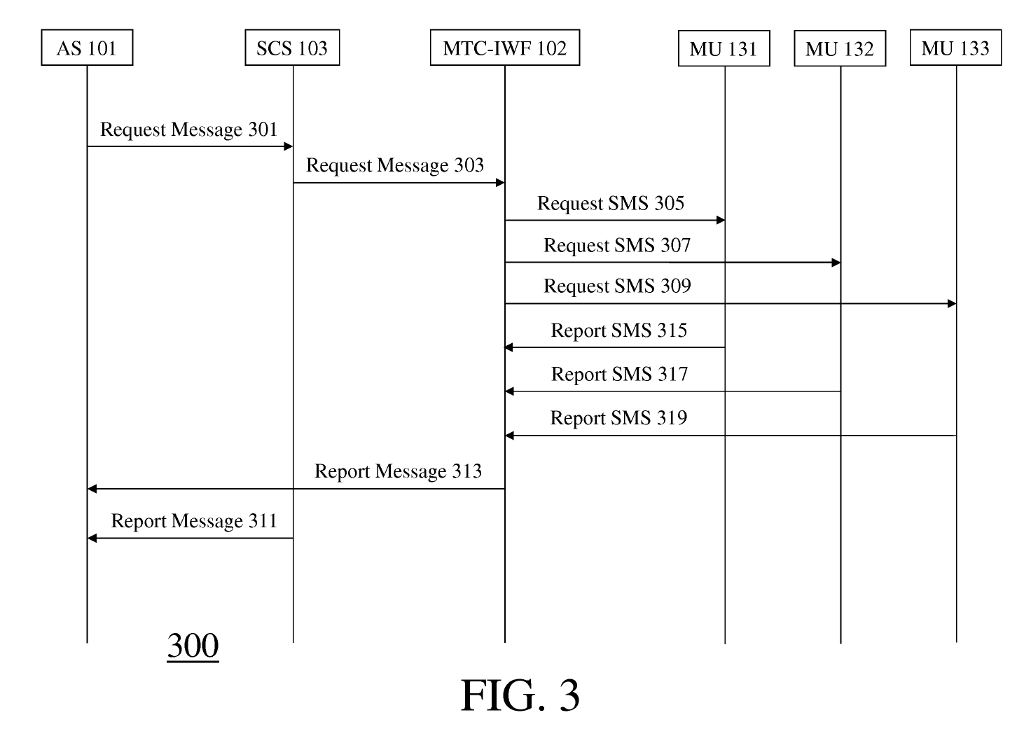

FIG. 3 depicts a call flow diagram 300 in accordance with an exemplary embodiment of the present invention. In this exemplary embodiment, an MTC service provider utilizes an application server to request information from one or more remote devices. For example, the MTC service provider may request inventory information from multiple remote devices.

In accordance with this exemplary embodiment, the MTC service provider provides a request to AS 101. The request includes the destination addresses of the selected remote machine devices and an event request ID. In this exemplary embodiment, the remote machine devices are mobile unit 131, mobile unit 132, and mobile unit 133.

AS 101 sends request message 301 to SCS 103. Request message 301 includes the destination addresses of MU 131, MU 132, MU 133, and the event request ID.

SCS 103 sends request message 303 to MTC-IWF 102. Request message 301 includes the destination addresses of MU 131. MU 132, MU 133, and the event request ID.

MTC-IWF 102 generates an SMS request and sends request SMS 305 to MU 131. Request SMS 305 includes the event request ID, preferably in the PDU (Protocol Data Unit) body.

MTC-IWF 102 generates an SMS request and sends request SMS 307 to MU 132. Request SMS 307 includes the event request ID, preferably in the PDU body.

MTC-IWF 102 generates an SMS request and sends request SMS 309 to MU 133. Request SMS 309 includes the event request ID, preferably in the PDU body.

Although shown separately, request messages 305, 307, and 309 can alternately be sent simultaneously.

MU 131 receives request SMS 305 and saves the event request ID. In an exemplary embodiment, MU 131 saves the event request ID in read-only memory (ROM).

In a similar way, MU 132 receives request SMS 307 and saves the event request ID, preferably in ROM. MU 133 receives request SMS 309 and saves the event request ID, preferably in ROM.

After obtaining the information requested, such as inventory information, MU 131 sends report SMS 315 to MTC-IWF 102. Report SMS 315 is an MO SMS. Report SMS 315 includes the information requested, such as inventory information, and the event request ID received in request SMS 305. In an exemplary embodiment, the event request ID is included in the PDU body.

After obtaining the information requested, such as inventory information, MU 132 sends report SMS 317 to MTC-IWF 102. Report SMS 317 is an MO SMS. Report SMS 317 includes the information requested, such as inventory information, and the event request ID received in request SMS 307. In an exemplary embodiment, the event request ID is included in the PDU body.

After obtaining the information requested, such as inventory information, MU 133 sends report SMS 319 to MTC-IWF 102. Report SMS 319 is an MO SMS. Report SMS 319 includes the information requested, such as inventory information, and the event request ID received in request SMS 309. In an exemplary embodiment, the event request ID is included in the PDU body.

It should be understood that Request SMS messages 305, 307, and 309 can be sent concurrently or at different times. It should also be understood that Report SMS messages 315, 317, and 319 may not be sent in the order shown in the exemplary embodiment as depicted in FIG. 3.

Upon receiving the first Report SMS message, for example Report SMS 315 in FIG. 3, MTC-IWF 102 preferably marks the completion of the event request for the event request ID used in the request messages.

Upon receiving Report SMS 317, MTC-IWF 102 preferably marks the completion of the event request for the event request ID used in request SMS 307.

Upon receiving Report SMS 319, MTC-IWF 102 preferably marks the completion of the event request for the event request ID used in request SMS 309.

MTC-IWF 102 sends report message 313 to SCS 103. Report message 313 includes the information requested and the event request ID.

SCS 103 sends report message 311 to AS 101. Report message 311 includes the information requested and the event request ID.

The MTC service provider may request a charging bill for the event request ID. In this exemplary embodiment, the billing statement includes the cost of all SMS messaging between the MTC service provider and mobile units 131, 132, and 133.

While this invention has been described in terms of certain examples thereof, it is not intended that it be limited to the above description, but rather only to the extent set forth in the claims that follow.

We claim:

1. A method for requesting information from a remote device, the method comprising:
sending a request to a remote device from a network element, the request including a data request and an event request ID; and
receiving a response from the remote device at the network element, the response including information requested and the event request ID.

2. A method for requesting information from a remote device in accordance with claim 1, wherein the request includes a PDU (Protocol Data Unit) body, and wherein the PDU body includes the event request ID.

3. A method for requesting information from a remote device in accordance with claim 1, the method further comprising the step of marking the completion of an event associated with the event request ID.

4. A method for requesting information from a remote device in accordance with claim 1, the method further comprising the step of sending a second request to the remote device from the network element, the second request including the event request ID.

5. A method for requesting information from a remote device in accordance with claim 4, wherein the request includes a number of reports that the network element would like to receive from the remote device.

6. A method for requesting information from a remote device in accordance with claim 4, wherein the request includes a number of reports to be sent.

7. A method for requesting information from a remote device in accordance with claim 4, wherein the request includes a time interval for sending the response.

8. A method for requesting information from a remote device in accordance with claim 7, wherein the response is received after expiration of the time interval.

9. A method for requesting information from a remote device in accordance with claim 8, wherein the information requested includes collected data.

10. A method for requesting information from a remote device in accordance with claim 8, wherein the response is a mobile originated (MO) SMS message.

11. A method for requesting information from a remote device in accordance with claim 4, the method further comprising the step of correlating data in the response.

12. A method for requesting information from a remote device in accordance with claim 11, wherein the step of correlating data in the response comprises correlating data in the response utilizing the event request ID.

13. A method for requesting information from a plurality of remote devices, the method comprising:
sending a first request to a first remote device from a network element, the first request including a first data request and an event request ID;
sending a second request to a second remote device from the network element, the second request including a second data request and the event request ID; and
receiving a response from the remote device at the network element, the response including information requested and the event request ID.

14. A method for requesting information from a plurality of remote devices in accordance with claim 13, wherein the first request includes a PDU (Protocol Data Unit) body, and wherein the PDU body includes the event request ID.

15. A method for requesting information from a plurality of remote devices in accordance with claim 13, wherein the step of sending the first request and the step of sending the second request are done concurrently.

16. A method for requesting information from a plurality of remote devices in accordance with claim 13, the method further comprising the step of marking the completion of an event associated with the event request ID.

17. A method for requesting information from a plurality of remote devices in accordance with claim 13, the method further comprising the step of billing based upon the event request ID.

18. A method for requesting information from a plurality of remote devices in accordance with claim 13, the method further comprising the step of rejecting the response if it does not include the event request ID.

19. A method for sending information from a remote device, the method comprising:
receiving a request at a remote device from a network element, the request including a data request and an event request ID; and
sending a response from the remote device to the network element, the response including information requested and the event request ID.

20. A method for sending information from a remote device in accordance with claim 19, the method further comprising the step of saving the event request ID at the remote device.
